(19) United States
(12) Patent Application Publication
(10) Pub. No.: US 2015/0161292 A1
(43) Pub. Date: Jun. 11, 2015

(54) METHOD FOR RECOMMENDING DOCUMENT

(71) Applicant: RICHPLAY INFORMATION CO., LTD., New Taipei City (TW)

(72) Inventors: PEI-HSUN TSAI, NEW TAIPEI CITY (TW); JUN-HUI WU, NEW TAIPEI CITY (TW); CHAN-SAN LAUO, NEW TAIPEI CITY (TW); MIN-HSIUNG CHEN, NEW TAIPEI CITY (TW)

(21) Appl. No.: 14/554,641

(22) Filed: Nov. 26, 2014

(30) Foreign Application Priority Data
Dec. 5, 2013 (TW) 102144709

(51) Int. Cl. G06F 17/30

(52) U.S. Cl. CPC G06F 17/30973; G06F 17/3053; G06F 17/30867

(57) ABSTRACT

A method for recommending document is revealed. First give respective first document an interest score or arranged the respective first document in order by a first device. According to the interest score or an interested list generated by the first device, the first servers arranged the respective first document in a specific set to get a recommendation list. Then search a piece of second document by a second device. When the second document is included in the specific set, the first server sends the first document in the specific set into the second device according to the order recorded in the recommendation list. Thus the document included in the specific set and other users are interested in is actively recommended to the user of the second device.

### BACKGROUND OF THE INVENTION

1. Fields of the Invention

The present invention relates to a method for recommending document, especially to a method for recommending document by which various users' interest and preference to document are analyzed so as to arrange document in specific sets in order and get a recommendation list. When a user is searching for at least one document in the set, the rest documents in the set that includes the document being searched is recommended to the user according to the order in the recommendation list.

2. Descriptions of Related Art

Nowadays, our society is a union of knowledge unprecedented prosperity, and information increases suddenly like an explosion. The term “explosion of knowledge” describes the rapid increase in the amount and growth speed of the knowledge since the mid 21-century. A common side effect of the explosion of knowledge is “information anxiety”. People feel anxious while being overwhelmed by the information and when they think the information they have is not the information they really need.

In order to reduce the information anxiety, to screen the useful information in advance is more effective and practical than to absorb all the information as more as we can. One of the effective screening ways for users is to get the information the user may require by a recommendation mechanism. Thus the time the user required for searching, collecting and screening the information is significantly reduced by active recommendation.

An effective book recommendation tool should help users to screen book-related information and create a book list they need quickly. Generally a system developer classifies the books and calculates page views or purchase rate of the respective book so as to recommend users the more popular or hot books with higher priority. However, the above way can only calculate the number of the user's behavior and the users' interest or preference to the book is unable to be reflected. For example, different users have reviewed the page of the same book may have a different degree of interest in this book. Similarly, the users buy the same book may have different preference to the book.

There is room for improvement and a need to provide a novel method for recommending document. Instead of simplifying the user's behavior, the users scores the document according to their interest and preference, or arrange the books in order, quantify the ordering and record the order in a recommendation list. The order of the document in the recommendation list can be modified dynamically according to other users' scoring or ordering so as to keep accuracy of the recommendation list that reflects the interest or preference of the readers at recent time.

Thus the present invention provides a method for recommending document having a plurality of steps. First give respective first document an interest score or arrange the respective first document in order by a first device. Then the first server arrange the included respective first document in a specific set in order according to the interest score or interest list generated by the first device so as to get a recommendation list. Next search a piece of second document by a second device. When the second document is included in the specific set, the first server sends the first document included in the specific set to the second device according to the order recorded in the recommendation list. Thus the document included in the specific set and other users are interested in is actively recommended to the user of the second device.

### SUMMARY OF THE INVENTION

Therefore it is a primary object of the present invention to provide a method for recommending document that analyzes various users' interest and preference to respective document and arranges a plurality of pieces of document in a specific set so as to get a recommendation list. When a user is searching a piece of document, the document included in the set is recommended to the user according to the order in the recommendation list of the set once the piece of document being searched is included in the set.

It is another object of the present invention to provide a method for recommending document by which users can get scores or the order of specific document and users can record their own interest and preference to the document for following searching and use of the document.

In order to achieve the above objects, a method for recommending document of the present invention users a first server, at least one first device and at least one second device connected to the first server. The method include following steps. First the first server arranges at least one first document included in a set in order and records the order in a recommendation list. Then the second device is searching a second document. Once the second document is included in the set, the first server sends at least one first document to the second device according to the order in the recommendation list.

For reflection of various users' interest or preference to respective document, the first server gives an interest score to the first document included in the set or arranges the first document included in the set in order and records the order in an interest list. Then the first server calculates the interest score of respective first document in the set given by the respective user of the first device or users the ordering result of respective first document included in the set recorded in the interest list to set up the recommendation list. When the second document that a user of the second device is searching is included in the set, the respective first document the first device's user is more interested or preferred is recommended to the user of the second device according to the recommendation list so as to save the time the user of the second device requires to search the rest document included in the same set and other users' are interested in.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a schematic drawing showing relationship among components of an embodiment according to the present invention;

FIG. 1B is a flow chart showing steps of an embodiment according to the present invention;

FIG. 2A is a schematic drawing showing relationship among components of another embodiment according to the present invention;

FIG. 2B is a flow chart showing steps of another embodiment according to the present invention;

FIG. 3 is a schematic drawing showing relationship among components of a further embodiment according to the present invention;

FIG. 4A is a schematic drawing showing relationship among components of a further embodiment according to the present invention;

FIG. 4B is a flow chart showing steps of a further embodiment according to the present invention.

### DETAILED DESCRIPTION OF THE PREFERRED EMBODIMENT

Please refer to the following embodiments and detailed descriptions in order to learn features and functions of the present invention.

A method for recommending document of the present invention features on that of the present invention features on that different users' preferences to various document are analyzed by a server through scoring or ordering. A plurality of pieces of document in a specific set is arranged in order so as to form a recommendation list. When a user is searching a piece of document, the set that includes the document is found out and the pieces of the document in the set are recommended to the user according to the order in the recommendation list of the set. Compared with the conventional method for recommending documents, the recommendation list obtained by the present invention reflects user's interest or preference more accurately. Moreover, the user can record his interest and preference to various document by the method of the present invention for convenience of following searching.

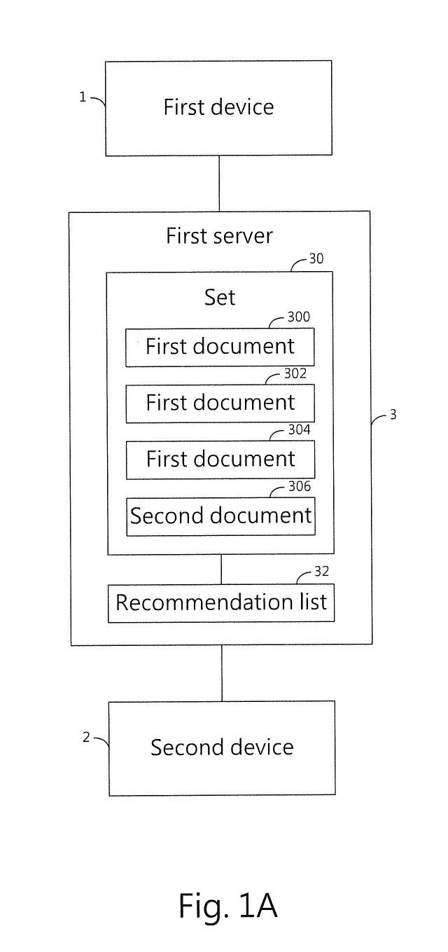

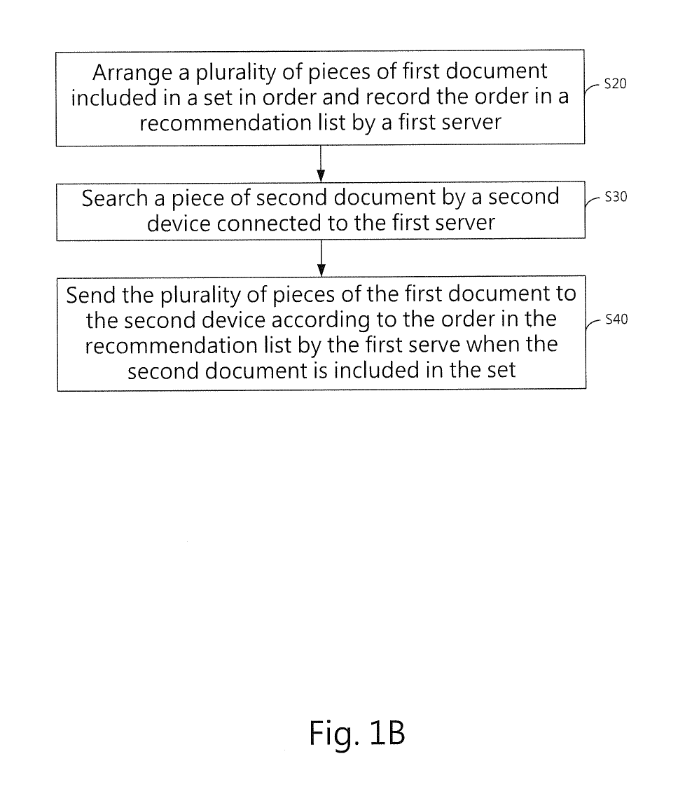

Refer to FIG. 1A and FIG. 1B, a method for recommending document of the present invention includes at least one first device 1, a second device 2 and a first server 3. The first device 1 and the second device 2 are connected to the first server 3 respectively. A set 30 and a recommendation list 32 are recorded in the first server 3. The set 30 includes a plurality of pieces of first document 300, 302, 304 and a piece of second document 306 therein while the recommendation list 32 records the order of the first document 300, 302, 304 in the set 30. In this embodiment, the respective first document 300, 302, and 304 or the second document 320 is information of a book and includes a book name, an author name, name of publisher, table of contents, book preface, book introduction, a part of text in electronic form or full text in electronic form.

As shown in FIG. 1B, the method for recommending document of the present invention includes at least following steps:
Step S20: arrange a plurality of pieces of first document included in a set in order and record the order in a recommendation list by a first server;
Step S30: search a piece of second document by a second device connected to the first server;
Step S40: send the plurality of pieces of the first document to the second device according to the order in the recommendation list by the first serve when the second document is included in the set.

In this embodiment, the pieces of the first document 300, 302, 304 and the second document 306 are stored in the first server 3. The first device 1 or the second device 2 can read or search the pieces of the first document 300, 302, 304 or the second document 306 in the first server 3. In the step S20, the first server 3 arrange the pieces of the first document 300, 302, 304 included in the set 30 in order and record an ordering result in the recommendation list 32. In the step S30, a user of the second device 2 searches the second document 306 in the first server 3. In the step S40, once the first server 3 checks that the second document 306 is included in the set 30, the first server 3 sends the pieces of the first document 300, 302, 304 according to the order in the recommendation list 32.

By the above steps S20 to S40, the method for recommending document of the present invention can be applied to various conditions. First the first server 3 that stores various document and record respective set as well as respective recommendation list can be used as a tool for recommending document to users. When a user of the second device 2 is searching the second document, 306, the rest document 300, 302, 304 in the set 30 that includes the second document, 306 is recommended to the user of the second device 2 according to the order recorded in the recommendation list 32. Thus the user of the second device 2 gets the first document easily through recommendation and the time required for collecting the first document is saved. Moreover, if the set 30 includes too many pieces of document, only a certain number of the first document is recommended according to the order of the recommendation list 32 due to setting of the program developer or the user of the second device 2.

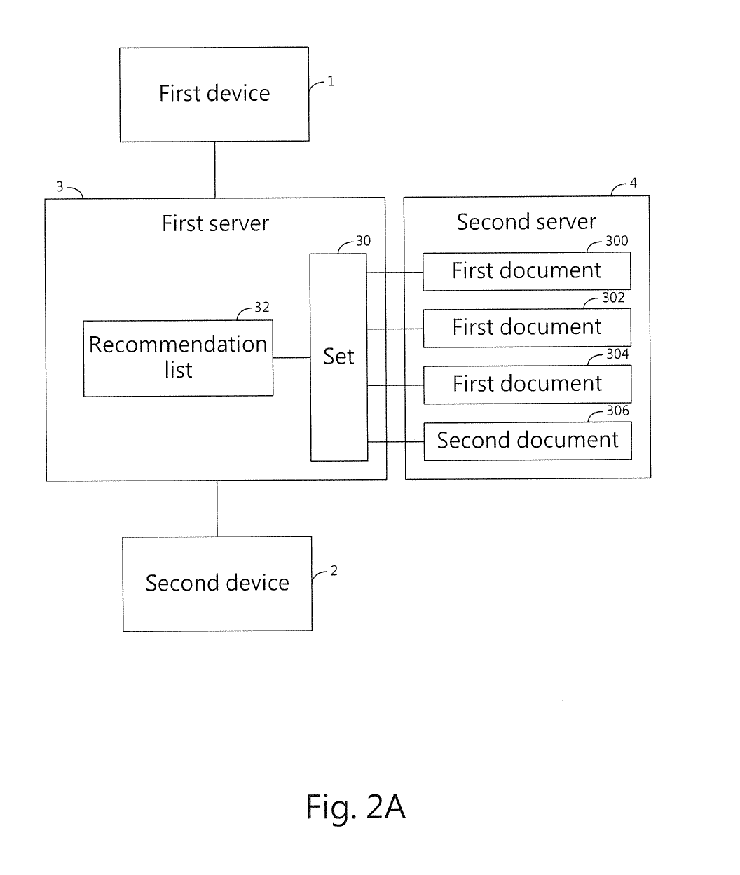

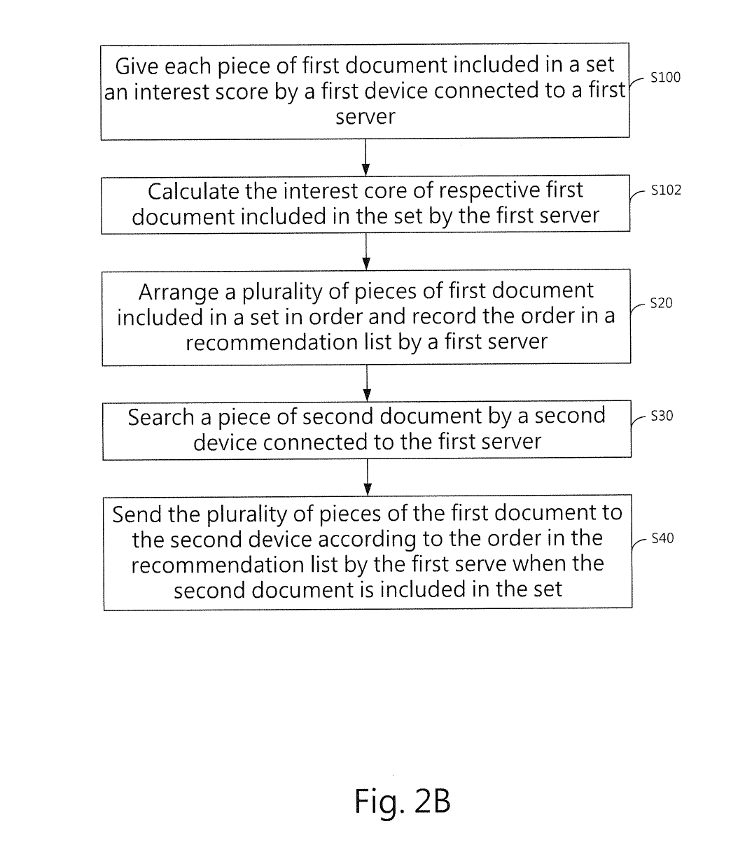

Refer to FIG. 2A and FIG. 2B, components and steps of another embodiment are disclosed. As shown in FIG. 2A, besides a first device 1, a second device 2 and a first server 1, the embodiment of the method for recommending document further includes a second server 4. A plurality of pieces of first document 300, 302, 304 and a piece of second document 306 are stored in the second server 4. The first device 1 and the second device 2 are connected to the first server 3 respectively and further indirectly connected to the second server 4 through the first server 3. A set 30 and a recommendation list 32 are recorded in the first server 3. The first server 3 also records that the first document 300, 302, 304 and the second document 306 are included in the first set 30 while the recommendation list 32 records the order of the first document 300, 302, 304 included in the set 30. As mentioned above, the respective first document 300, 302, and 304 or the second document 320 includes a book name, an author name, name of publisher, table of contents, book preface, book introduction, a part of text in electronic form or full text in electronic form.

As shown in FIG. 2B, this embodiment further includes following steps before the step S20:
Step S100: give each piece of first document included in a set an interest score by a first device connected to a first server.
Step S102: calculate the interest core of respective first document included in the set by the first server.

In the step S100, the user of the first device 1 gives the pieces of the first document 300, 302, 304 included in the set 30 an interest score by the first device 1. For example, the first document 300 is scored 10, the first document 302 is scored 8 and the first document 300 is scored 5. In the step S102, the first server 3 calculates the result of the interest score of the pieces of the first document 300, 302, 304. That means when there is a plurality of users is scoring the pieces of the first document 300, 302, 304, the first server 3 can calculate the total average value of the scores given by respective users.

In the step S20, the first server 3 arranged the pieces of the first document 300, 302, 304 included in the set 30 in turn according to the statistic result of the interest score obtained in the step S102. The pieces of the first document 300, 302, 304 are arranged in the sequence of the first document 300 (with the interest score of 10), the first document 302 (with the interest score of 8) and the first document 304 (with the interest score of 5) and the order is recorded in the recommendation list 32. In the step S40, the pieces of the first document 300, 302, 304 are recommended to the user of the second device 2 according to the order.

By the above components and the steps, the method for recommending document of the present invention can be applied to the condition that respective document is stored in the second server 4 while the both the first device 1 and second device 2 are connected to the second server 4 through the first server 3. The user of the first device 1 can score the pieces of the first document 300, 302, 304 he is interested in and the first server 3 records the interest scores. Then the first server arranges the pieces of the first document 300, 302, 304 included in the set 30 in turn according to the interest score and records the order in the recommendation list 32. For the user of the first device 1, the present invention can be used as a tool for manage the interest lists of the document. As to the user of the second device 2, the present invention can find out the set 30 including the second document 306 the user is searching and recommend the rest document 300. 302. 304 included in the set 30 to the user according to other users' interest. Thus the document preferred by other users and included in the same set with the searched document is recommend actively.

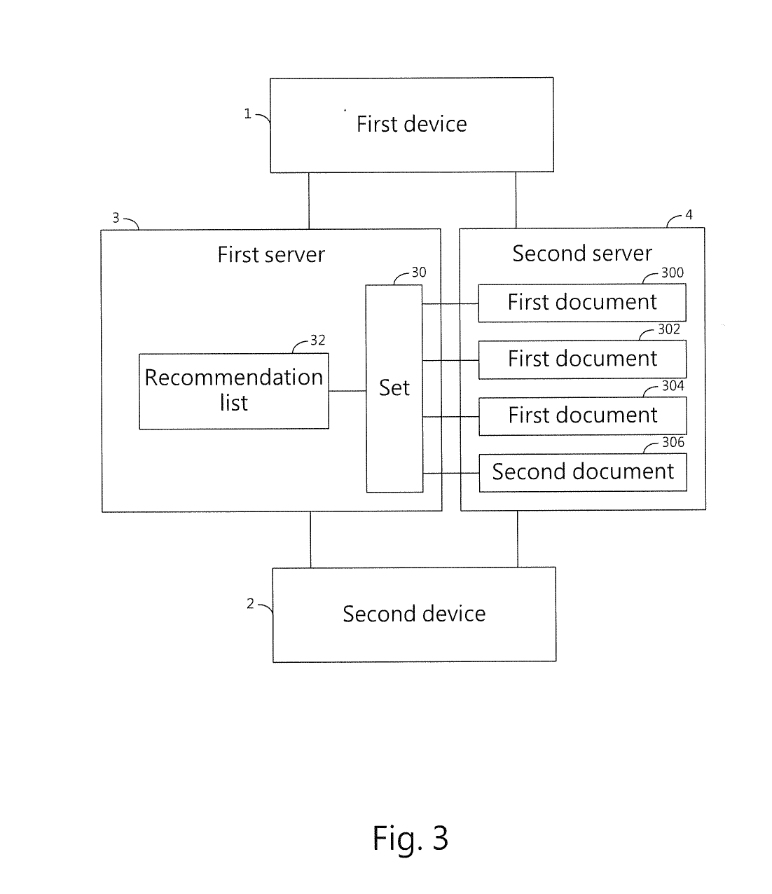

Moreover, as shown in FIG. 3, the first device 1 and the second device 2 can be independently connected to the first server 3 and the second server 4. This embodiment can also achieve similar effects as the second embodiment through the step S100 to the step S40.

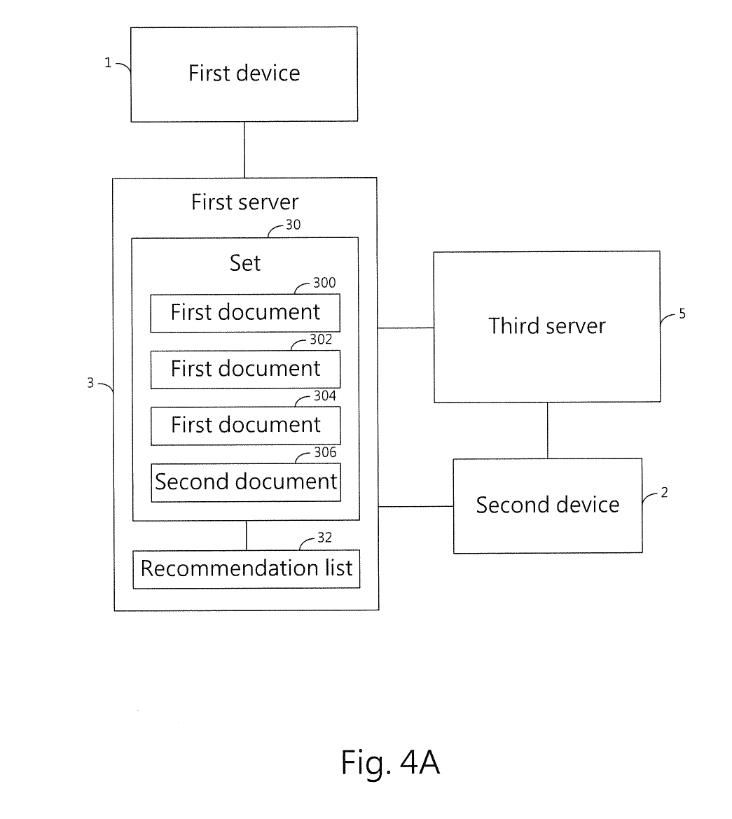

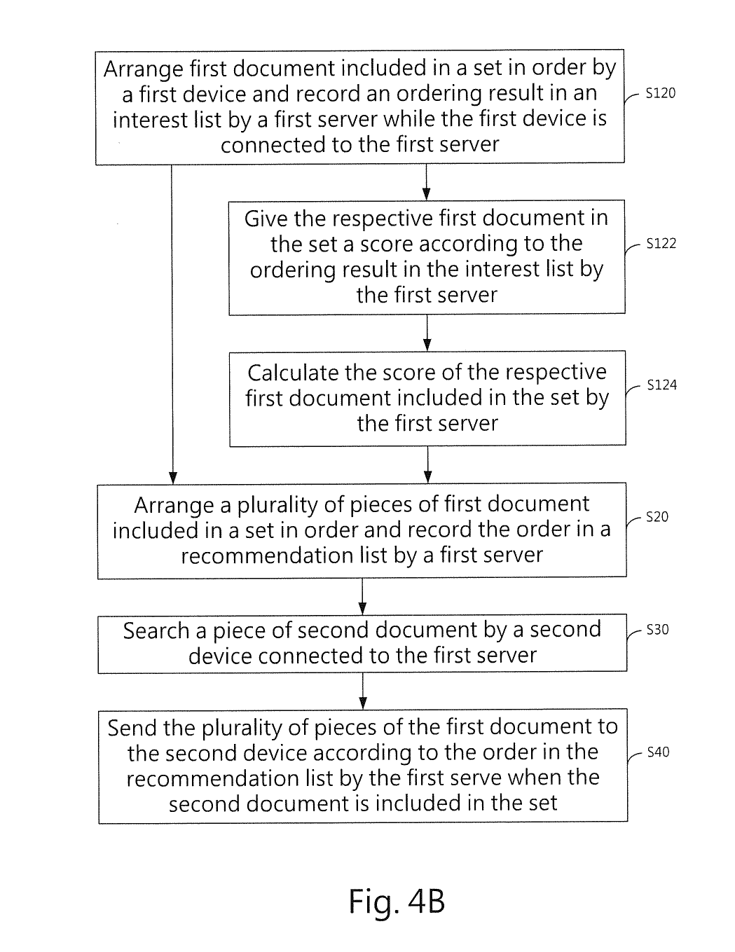

Refer to FIG. 4A and FIG. 4B, components and steps of a fourth embodiment are disclosed. As shown in FIG. 4A, besides a first device 1, a second device 2 and a first server 1, the embodiment of the method for recommending document further includes a third server 5. The first device 1, the second device 2 and the third server 5 are connected to the first server 3 respectively while the second device 2 is further connected. The same as the first embodiment, a set 30 and a recommendation list 32 are recorded in the first server 3. A plurality of pieces of first document 300, 302, 304 and a piece of second document 306 are included in the set 30. The recommendation list 32 records the order of the first document 300, 302, 304 included in the set 30. The respective first document 300, 302, and 304 or the second document 320 includes a book name, an author name, name of publisher, table of contents, book preface, book introduction, a part of text in electronic form or full text in electronic form.

As shown in FIG. 4B, this embodiment further includes following step before the step S20:
Step S120: arrange first document included in a set in order by a first device and record an ordering result in an interest list by a first server while the first device is connected to the first server.

In the step S120, a user of the first device 1 arranges a plurality of pieces of first document 300, 302, 304 in order according to his preference. The pieces of the first document 300, 302, 304 are defined to be included in a set 30. Then the first document 300, 302, 304 is arranged in the sequence of the first document 300, the first document 302, and the first document 304. The first server 3 records the ordering result in an interest list (not shown in figure).

The first server 3 arranges the pieces of the first document 300, 302, 304 in the set 30 in order according to the interest list obtained in the step S120 while the pieces of the first document 300, 302, 304 are recommended to the user of the second device 2 according to the order in the step S40.

For convenient use of the ordering result records in the interest list, the embodiment of the present invention further includes the following steps between the step S120 and the step S20:
Step S122: give the respective first document in the set a score according to the ordering result in the interest list by the first server;
Step S124: calculate the score of the respective first document included in the set by the first server.

In the step S122, the first server 3 further converts the ordering result in the interest list into a scoring result. For example, the last piece of the first document is scored 1, the second last piece of the first document is scored 2, and so on. In this embodiment, the first document 300 is scored 3, the first document 302 is scored 2 and the first document 304 is scored 1. In the step S124, the server 3 calculates the scoring result of the respective first document 300, 302, 304. That means when there is a plurality of users giving the respective first document 300, 302, 304 a score, the first server 3 can carry out weighted correction on the scoring result of respective user (the score with less amount should be weighted magnified) and calculate the total average value. Thus in the step S20, the first server 3 arranges the pieces of first document 300, 302, 304 included in the set in order according to the calculation result of the score.

By the components and the steps mentioned above, the user of the first device 1 can arrange the pieces of the first document 300, 302, 304 he is interested in in order and record the ordering result in the interest list by the first server 3. The first server 3 arranges the pieces of the first document 300, 302, 304 in the set 30 in order according to the recommendation list 32 and records the order in the recommendation list 32. For the user of the first device 1, the present invention can be used as a tool for managing the interest list of the document. As to the user of the second device 2, the present invention can recommended him the pieces of the first document 300, 302, 304 according to other user's preference when the second document being searched is included in the set 30. Thus the document preferred by other users and included in the same set with the searched document can be recommend to the user actively.

In summary, the method for recommending document of the present invention can get the recommendation list reflecting most users' interest and preference to the document by the users' ordering or scoring of the document. Moreover, the rest document in the set having the searched document is actively recommended to a user when the user is searching a piece of document. Thus the time the user required for searching the document can be saved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for recommending document comprising the steps of:
arranging at least one piece of first document included in a set in order and recording the order in a recommendation list by a first server;
searching a piece of second document by a second device connected to the first server; and
sending the at least one pieces of the first document to the second device according to the order in the recommendation list by the first serve when the second document is included in the set.

2. The method as claimed in claim 1, wherein before the step of arranging at least one piece of first document included in a set in order and record the order in a recommendation list by a first server, the method further includes the steps of:
giving at least one piece of first document included in a set an interest score by at least one first device connected to a first server; and
calculating the interest core of respective first document included in the set by the first server;
wherein the first server arranges the first document in the set in order according to the calculation result of the interest score.

3. The method as claimed in claim 1, wherein before the step of arranging at least one piece of first document included in a set in order and record the order in a recommendation list by a first server, the method further includes a step of:
arranging at least one piece of first document included in a set in order by at least one first device connected to a first server and recording an ordering result in an interest list;
wherein the first server arranges the first document in the set in turn according to the ordering result in the interest list.

4. The method as claimed in claim 3, wherein between the step of arranging at least one piece of first document included in a set in order by at least one first device connected to a first server and recording an ordering result in an interest list and the step of arranging at least one piece of first document included in a set in order and record the order in a recommendation list by a first server; the method further includes the steps of
giving the respective first document in the set a score according to the ordering result in the interest list by the first server; and
calculating the score of the respective first document included in the set by the first server;
wherein the first server arranges the first document in the set in order according to calculation result of the score.

5. The method as claimed in claim 1, wherein the first document or the second document is stored in the first server.

6. The method as claimed in claim 1, wherein the first document is stored in a second server.

7. The method as claimed in claim 6, wherein the first device or the second device is connected to the second server through the first server.

8. The method as claimed in claim 6, wherein the first device or the second device is connected to the first server and the second server respectively.

9. The method as claimed in claim 1, wherein the second device is searching the second document in the first server.

10. The method as claimed in claim 1, wherein the second device is connected to the first server and the third server respectively; the second device is searching the second document in the third server.
